(19) United States
(12) Patent Application Publication
(10) Pub. No.: US 2017/0014935 A1
(43) Pub. Date: Jan. 19, 2017

(54) INERT GAS AND METHOD OF METAL INERT-GAS WELDING FOR POLLUTANT REDUCTION

(71) Applicant: LINDE AKTIENGESELLSCHAFT, Munchen (DE)

(72) Inventors: Ernst Miklos, Kirchheim (DE); Faith Savgu, Karlsfeld (DE)

(21) Appl. No.: 15/116,244

(22) PCT Filed: Feb. 16, 2015
(86) PCT No.: PCT/EP2015/000337

§ 371 Date: Aug. 3, 2016

(30) Foreign Application Priority Data
Feb. 18, 2014 (DE) 10 2014 002 349.4

(51) Int. Cl. B23K 9/173; B23K 35/38; B23K 9/23

(52) U.S. Cl. CPC B23K 9/173; B23K 9/23; B23K 35/383; B23K 2203/04

(57) ABSTRACT

A method of metal inert-gas welding is proposed, a method in which a welding filler (1) is fed to a welding torch (10) and a welding current of a welding current source (30) is applied via a welding current connection (5), whereby an arc (7) is formed and, in a welding region, material of the welding filler (1) is transferred to a workpiece (20) consisting at least in the welding region of an alloyed high-grade steel. By means of the welding torch (10), an inert gas that includes a content of 0.5 to 3.0 percent by volume of at least one oxidizing component and a content of 0.1 to below 0.5 percent by volume of hydrogen is fed to the welding region. A method of reducing the content of nickel oxides and chromium (VI) compounds in welding fumes of such a welding method, a corresponding inert gas and the use of a gas mixture as an inert gas are likewise the subject of the present invention.

The invention relates to a welding method, a method for reduction of nickel oxides and/or chromium (VI) compounds in a welding fumes of such a welding method, a hydrogen and an inert gas containing at least one oxidising component for use in the mentioned methods and the use of a hydrogen and an inert gas containing at least one oxidising component t in these methods.

### PRIOR ART

The person skilled in the art is familiar with different welding methods from the prior art which in each case are suitable for certain technical welding tasks in a particular way. An overview is given for example by Dilthey, “Schweiβtechnische Fertigungsverfahren. 1: Schweiβ- und Schneidtechnologien”, 3^{rd} Heidelberg: Springer, 2006 bzw. Davies, A. C.: “The Science and Practice of Welding”, 10th edition Cambridge: Cambridge. University Press, 1993.

The present invention relates to a welding method, in the case of which a wire-shaped welding filler is employed and melted in an arc, namely the metal inert as welding. During the metal inert gas welding, the welding torch is continuously fed a wire electrode which thereby forms a welding filler at the same time and is melted in an arc. For protecting the melting puddle which forms and if applicable also the solidifying weld seam from oxidation, a suitable inert gas is employed which covers the welding region. Depending on the type of the inert gas, the person skilled in the art distinguishes metal inert gas welding (MIG) and metal active gas welding (MAG). The fundamental method principles are similar. Typically, a metal inert gas welding torch is supplied with the welding current, the wire electrode, the inert gas and any required cooling water by way of a hose package.

Metal inert gas welding methods allow a high welding speed and thus a superior productivity compared with methods in which non-melting electrodes are employed, such as for example tungsten inert gas welding (TIG). The automatability of metal inert gas welding methods is extremely high. Disadvantageous in using the welding filler which is directly heated, melted and partly evaporated in the arc is the significantly elevated emission of particles and harmful vapours, so-called welding fumes, compared with methods with non-melting electrode. This applies in particular when high-alloyed materials such as stainless or chromium steels are welded.

In the welding fumes, chromium (VI) compounds and nickel oxides are particularly problematic as explained in the information sheet number 036, “chromium (VI)” compounds and nickel oxides during welding and with related methods “protective measures at the workplace” of the Technical Committee Metal and Surface Treatment of the German Compulsory Accident insurance, Edition 11/2008, or the corresponding fact sheet “controlling hazardous fume and gases during welding” of the Occupational Safety and Health Administration of the US Department of Labour. Chromium (VI) compounds and nickel oxides can have a carcinogenic effect on humans.

Chromium (VI) compounds are formed in particular during metal inert gas welding methods in which welding fillers that are highly alloyed with chromium are employed. Chromium (VI) compounds occur mostly in the form of chromates such as for example sodium chromate (Na₂CrO₄), potassium chromate (K₂CrO₄) or calcium chromate (CaCrO₂) or also in the form of chromium trioxide (CrO₃). The mentioned nickel, oxides (NiO, NiO₂, Ni₂O₃) develop mainly during the welding with nickel and nickel-based alloys or nickel-based materials, in particular with the previously explained metal inert can welding.

To avoid the exposure to chromium (VI) compounds and nickel oxides at the workplace, the use of scavengers such as silanes, the conversion to low-pollution methods (for example TIG welding), the optimisation of the welding parameters, favourable working positions, in which the respiratory region of the welder is located outside the trail of fumes, effective extraction in the region where the welding fumes is created and the use of personal protective equipment is recommended. However, these measures render the work sometimes substantially more difficult.

The object of the present invention therefore is to reduce the formation of nickel oxides and/or chromium (VI) compounds during the metal inert gas welding of stainless steel.

### DISCLOSURE OF THE INVENTION

This object is solved through a welding method, a method for reducing nickel oxides and/or chromium (VI) compounds in a welding fumes of such a welding method, a hydrogen and an inert gas containing at least one oxidising component for the mentioned methods, and the use of a hydrogen and an inert gas containing at least one oxidising component in these methods, as stated in the independent claims in each case. Preferred embodiments of the invention are in each case subject of the dependent patent claims and the following description.

### ADVANTAGES OF THE INVENTION

The invention starts out from a method for metal inert gas welding of the type known per se, i.e. a method in which a wire-shaped welding filler is fed to a welding torch and via a welding current connection supplied with a welding current of a welding current source. Because of this, an arc is formed and material of the welding filler is transferred in a welding region onto a work piece. The invention relates to a method which is employed for welding alloyed stainless steel. Accordingly, the work piece consists of alloyed stainless steel a least in the welding region and a corresponding welding filler is employed. During such a method, substantial quantities of the aforementioned compounds are conventionally formed.

“Stainless steel” according to EN 10020 is to mean an alloyed or unalloyed material with a particular degree of purity. These are steels for example, the sulphur and phosphorus content (so-called iron accompanying elements) of which does not exceed 0.025%. The alloyed stainless steels processed within the scope of the present invention contain, chromium as alloying component. These are for example alloyed stainless steels with the material numbers (MNo.) or designations of the AISI (American Iron and Steel Institute) stated in the following: MNo. 1.4003 (X2CrNi12); MNo. 1.4006 (X12Cr13), AISI 410; MNo. 1.4016 (X6Cr17), AISI 430; MNo. 1.4021 (X20Cr13), AISI 420; MNo. 1.4104 (X14CrMoS17), früher X12CrMoS17), AISI 430F; MNo. 1.4301 (X5CrNi18-10), AISI 304; MNo. 1.4305 (X8CrNiS18-9, früher X10CrNiS18-9), AISI 303; MNo. 1.4306 (X2CrNi19-11), AISI 304L; MNo. 1.4307 (X2CrNi18-9), AISI 304L; MNo. 1.4310 (X10CrNi18-8), früher X12CrNi17-7), AISI 301; MNo. 1.4316 (X1CrNi19-9); MNo. 1.4401 (X5CrNiMo17-12-2), AISI 316; MNo. 1.4404 (X2CrNiMo17-12-2), AISI 316L; MNo. 1.4440 (X2CrNiMo19-12), AISI 316L; MNo. 1.4452 (X13CrMnMoN18-14-3), P2000; MNo. 1.4462 (X2CrNiMoN22-5-3); MNo. 1.4541 (X6CrNiTi18-10), AISI 321; MNo. 1.4571 (X6CrNiMoTi17-12-2), AISI 316Ti; MNo. 1.4581 (GX5CrNiMoNb19-11-2); MNo. 1.4841 (X15CrNiSi25-21), previously X15CrNiSi25-20); MNo. 1.6582 (34CrNiMo6).

Welding methods for welding other materials such as for example nickel-based materials fundamentally differ from methods for welding stainless steels. The person skilled in the art in the field of welding technology would not therefore employ methods or inert gases for the welding of nickel-based materials for the welding of stainless steels.

Accordingly, nickel-based materials, because of their alloy composition, behave differently from conventional stainless steels during metal inert as welding. In the melted state, nickel-based materials are substantially more viscous, which renders the material transfer in particular in the arc more difficult during the metal inert gas welding. This results among other things in that nickel-based materials cannot be welded with the same parameters as conventional stainless steels. Characteristic curves, which are pre-programmed for stainless steels for example in modern current sources, cannot be taken over for the welding of nickel-based materials. Accordingly, adapting the impulse geometry is necessary for example. There is therefore a need, of either different characteristics in the current source or a freely programmable current source in order to be able to carry out the adaptation required for nickel-based materials.

Furthermore, nickel-based materials and conventional stainless steels cannot be welded by metal inert gas welding using the same process gases. The substantially higher nickel content and additional alloying elements such as aluminium or titanium, which are added to the nickel-based materials for increasing the strength, have a high oxygen affinity. For this reason, inert process gases are recommended for the metal inert gas welding of nickel-based materials, in contrast with simple stainless steels or duplex steels, in the case of which corresponding active components (e.g. carbon dioxide or oxygen) up to 3% are usual. When easily active gases are used for nickel-based materials, the oxygen and/or carbon dioxide proportion is around less than 0.1%, i.e. substantially below the values which are employed with conventional stainless steels (as mentioned, up to 3%). If nickel-based materials were to be welded with such highly-oxidising gases, alloying elements would be burnt off, the absence of which in the product being welded and the diffusion-impairing heat influence zone would bring with it serious metallurgical disadvantages. These are optically detectable to the person skilled in the art.

The present invention is based on the surprising realisation that by using a hydrogen and an inert as containing at least one oxidising component with the contents mentioned in the following during the welding of stainless steel the content of harmful nickel oxides and chromium (CI) compounds in the welding fumes can be significantly reduced. Disadvantageous effect occurs when using an inert gas which has a content of 0.5 to 3.0% by volume, in particular of 1.2 to 2.5% by volume, if applicable however even of 0.5 to 1.0% by volume, of 1.0 to 1.2% by volume, of 1.2 to 1.4% by volume, of 1.4% by volume to 1.6% by volume, of 1.6 to 1.8% by volume 1.8 to 2.0% by volume, of 2.0 to 2.5% by volume, of 2.5 to 3% by volume of the at least one oxidising component and of 0.1 to below 0.5% by volume, in particular of 0.1 to 0.4% by volume of hydrogen. This inert gas is fed to the welding region by means of the welding torch.

An “oxidising component” within the scope of this application is to mean a component which exerts an oxidising effect on the welded materials. The term is used here in the sense of ENISO 14175. Oxidising components are in particular oxygen and carbon dioxide. As is known, oxidising components have a positive influence on he process stability during the welding, in particular by an increase of the arc stability. A gas mixture employed within the scope of the present invention can also contain two or more oxidising components, for example oxygen and carbon dioxide. The indication of a content “of the at least one oxidising component” in such a case relates to the total content which is composed of the individual components.

According to the invention, a reducing component in the form of hydrogen is employed in addition to one or more oxidising components. As has surprisingly transpired, such a combination in particular with the contents stated above has a significantly reducing effect on the content of chromium (VI) compounds in the welding fumes. According to the current state of knowledge, this is attributable to the fact that at least two physically chemical influences are added up here:

On the one hand, the proportion of oxidation components is limited to an optimum so that the process still takes place in a stable manner but as little oxygen as possible is made available and thus the quantity of chromium oxides which develop is also restricted. A stable process is mandatorily required since in the case of instable processes ambient air is introduced into the arc region through turbulences and all chemical reactions become uncontrollable or the emission rates increase because of the oxygen in the air.

In addition, the arc however makes available sufficient energy (thermal, electrical) in order to dissociate the hydrogen proportions, However, hydrogen provided in atom form however reacts immediately with ozone subject to forming hydrogen and water:

O₃+2H⁺+2e⁻→O₂+H₂O

Since the hydrogen in atom form thus decomposes a part of the generated ozone, far fewer ozone molecules are available in order to allow the reactions (ii), (iii) and (v) stated below. By adding the two effects—limiting the oxidation components and use of hydrogen—which are matched to one another, the creation of chromium compounds is already limited. Because of this, the emissions are reduced.

This effect occurs to a lesser degree when in particular contents other than those mentioned of the at least one oxidising components are used. In this case, the welding process either becomes more instable or the welding process becomes stabilised but through the increased oxidation force of the gas mixture an increased formation of oxides occurs. In both cases, the effect of the reducing hydrogen would no longer be adequate. For technical reasons, in particular its combustability, the hydrogen content cannot be randomly increased.

“Chromium (VI) compounds” is to mean within the scope of this application all compounds of pentavalent chromium, among these the mentioned chromates sodium chromate (Na₂CrO₄), potassium chromate (K₂CrO₄) and calcium chromate (CaCrO₄) as well as chromium trioxide. Nickel oxides comprise nickel monoxide (NiO), nickel dioxide (NiO₂) and dinickel trioxide (Ni₂O₃), also oxygen compounds of bivalent, trivalent and quadrivalent nickel.

It has transpired that chromium (VI) compounds preferably from chromium (iii) compounds, in particular chromium (iii) oxide (Cr₂O₃),form in the presence of ozone, in the welding fumes. Chromium (VI) compounds however can also be formed directly from chromium with oxygen. The particularly critical ozone develops from oxygen under the effect of the ultraviolet radiation of the arc.

Typical reactions that are of interest within the scope of the present invention are combined in the following reaction equations:

2 Cr⁰+3 O₂→2 Cr⁶⁺O₃ (i)

Cr⁰+O₃→Cr⁶⁺O₃ (ii)

Cr³⁺₂O₃+O₃→2 Cr⁶⁺O₃ (iii)

Cr³⁺₂O₃+3/2 O₂→2 Cr⁶⁺O₃ (iv)

Cr³⁺₂O₃+O₃→2 Cr⁶⁺O₃ (v)

The effect of the inert gas used according to the invention is based among other things on the fact that through the comparatively low quantity of the at least one oxidising component the available oxygen is reduced. Because of this, significantly lower quantities of chromium (iii) compounds, in particular chromium (iii) oxide which can react further to form chromium (VI) compounds. Furthermore, the formation Of ozone is already substantially reduced because of this, as already mentioned.

As is known, carbon dioxide dissociates in the arc to form (comparatively stable) carbon monoxide and atomic oxygen. The carbon monoxide can further dissociate to form atomic carbon and atomic oxygen. By forming carbon and its introduction into the welding region, so-called carburization of the weld seam can occur. When the dissociation products of the carbon dioxide leave the immediate region of the arc and thereby reach a region with lower temperature, carbon monoxide and atomic oxygen can recombine in particular to form carbon dioxide. Little or no molecular oxygen, which would be available for the oxidation of chromium or nickel, is created. Atomic carbon can furthermore react with ozone, as a result of which molecular oxygen and carbon dioxide are formed. The available ozone reduces further because of this:

CO₂→CO+C (vi)

CO→C+O (vii)

C+2 O₃→CO₂+2 O₂ (vi)

The mentioned effects are amplified by the use of hydrogen. In the inert gas, hydrogen has a reducing effect and thus prevents further oxidation of chromium (iii) compounds to form chromium (VI) compounds or even beforehand oxidation of metallic chromium to form corresponding oxidation products for example two, three and four-valent chromium oxides (CrO, Cr₂O₃, CrO₂). A corresponding oxidation preventing effect also materialises when using the inert gas according to the invention with respect to the reduction of nickel oxides. Atomic hydrogen furthermore has a high affinity to ozone under the present conditions as mentioned and is therefore able to absorb ozone, as a result of which the advantages explained above with respect to carbon dioxide materialise. In a surprising manner it has been shown that even the mentioned low contents of hydrogen in the inert gas are adequate in order to achieve the mentioned effects.

The addition of carbon dioxide or of another oxidising component and hydrogen to a relevant inert gas thus brings about a synergistic effect during the reduction of the mentioned harmful compounds.

In the remaining proportion, i.e. the proportion of the inert gas which is not formed of carbon dioxide and/or at least one other oxidising component and hydrogen, such an inert gas contains argon or a mixture of argon and at least one further gas, for example helium. The argon proportion of this remaining proportion can for example amount to 100, 90, 80, 70, 60, 50, 40, 30, 20 or 10% by volume. The rest of the remaining proportion can consist of helium.

The present invention is suitable in a particular manner for chromium and nickel-alloyed stainless steels (so-called chromium-nickel steels), in particular for so-called high alloyed steels. The person skilled in the art uses the term “high-alloyed” steels in the case of a mass proportion of an alloying component above 5%.

A substantial advantage of the present invention materialises with welding methods during which chromium-containing weld fillers are employed, for example as wire-shaped weld fillers or melting electrodes in the mentioned methods. As mentioned, increased emissions occur here through the effect of the arc, in which the weld filler is directly melted and partly evaporated. Corresponding methods can therefore be carried out more securely based on the present invention.

In the method according to the invention, the weld fillers can be employed in all forms that are known from the prior art. Known weld fillers are provided as wires having diameters between 0.6 and 2.4 mm. Corresponding materials can for example comprise arc stabilisers, slag formers and alloying elements, which favour a calm welding process, contribute to an advantageous protection of the solidifying weld seam and positively influence the mechanical quality of the created weld seam.

The previously explained advantages materialise in the same way from the methods likewise claimed according to the invention for the reduction of nickel oxides and/or chromium (VI) compounds in a welding fumes of such a method. The hydrogen and inert gas containing at least one oxidising component proposed according to the invention for the mentioned methods and the use of a corresponding inert gas likewise result in the mentioned advantages.

An inert gas composed according to the invention can be provided in particular as premixed inert gas mixture which makes possible carrying out the welding method according to the invention in a particularly simple manner since a corresponding inert gas need not be elaborately mixed on location. A corresponding inert gas mixture can for example be provided in a pressure gas bottle, in the case of larger welding plants, in a corresponding pressure gas tank. A welding plant used for implementing the method according to the invention can therefore be realised in a simple and cost-effective manner.

By contrast, particularly high flexibility is achieved by a method which comprises the mixing of a corresponding inert gas on location. The main component of a corresponding inert gas in this case can be provided in liquid form for reducing the volumes to be transported and/or kept available. For example, a corresponding inert gas can be created in a method according to the invention from evaporating argon, helium and/or hydrogen with the admixture of the respective other components, which are kept available in a pressure gas tank. Even liquid pre-mixed components can also be used here.

The inert gas can also be mixed from commercially available gas mixtures, for example from a mixture with 97.5% by volume of helium and 2.5% by volume of carbon dioxide and a mixture of 97% by volume of argon with 3% by volume of hydrogen.

### BRIEF DESCRIPTION OF THE DRAWING

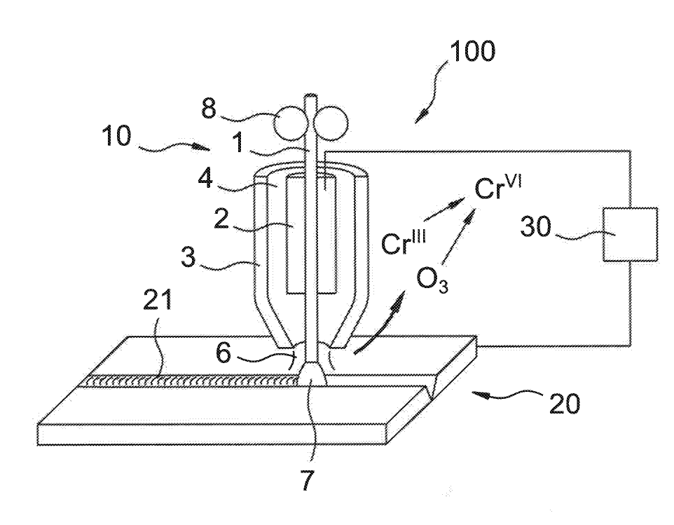

In the following, the invention is explained in more detail making reference to the attached drawing. In this drawing FIG. 1 illustrates the bases of the formation of chromium (VI) compounds by way of a schematic representation of a welding torch.

### COMPREHENSIVE FIGURE DESCRIPTION

FIG. 1 illustrates the chemical bases of the formation of chromium (VI) compounds by way of a schematic representation of a welding torch. The view in its entirety is marked with 100.

In the view 100, the welding torch 10 is shown in part view in longitudinal section. The welding torch 10 is designed as a metal inert gas welding torch. It is equipped in order to guide a wire-shaped welding filler 1 in the shown section and to this end comprises corresponding guide means 2, for example a guide sleeve with a suitable inner diameter. The welding torch 10 is directed at a work piece 20.

The guide means 2 are surrounded by a nozzle 3, which defines an annular process gas duct 4, which runs concentrically about the guide means 2 or the welding filler 1. By wav of the process gas duct 4, a suitable inert gas can be supplied by way of a suitable inert gas device (not shown), which covers a region 6 between the welding torch 10 and the work piece 20.

As metal inert gas welding torch, the welding torch 10 is designed in order to subject the welding filler 1 to a welding current. To this end, the guide means 2 are connected, by way of a welding current connection that is only schematically illustrated, with a pole of a suitable welding current source 30. The welding current source 30 is preferentially equipped for providing a direct and/or alternating current. In the shown example, the work piece 20 is connected to the other pole of the welding current source 30, as a result of which an arc 7 can be formed between the welding filler 1 and the work piece 20 (transmitted arc). In the same way, another element of the welding torch 10 however can also be connected with the other pole of the welding current source 30, so that between welding filler 1 and this other element of the welding torch 10 an arc is formed (untransmitted arc).

By way of a schematically illustrated feeding device 8, the welding filler 1 can be provided to the guide means 2 and conveyed at a suitable speed. By feeding the material 20 relative to the welding torch 10 or vice versa, a gradually solidifying weld seam 21 is formed.

The shown arrangement can also be surrounded by further nozzles, which can be used for feeding additional process gases. By way of a further annular process gas duct, a plasma gas can for example be fed in and a focussing gas via another annular process duct, so that by means of the welding torch 10 a plasma method can also be realised.

The liberation of chromium (iii) compounds (combined by Cr^{III}) from the welding region, i.e. the region of the arc 7, is illustrated by a corresponding arrow. By way of a reaction with the likewise formed ozone (O₃) the further oxidation to form chromium (VI) compounds (combined by Cr^{VI}) occurs.

1. A method for metal inert gas welding, in which a weld filler is fed to a welding torch and via a welding current connection is subjected to a welding current of a welding current source, as a result of which an arc is formed and material of the weld filler in a welding region is transmitted onto a work piece which at least in the welding region consists of alloyed stainless steel and an inert gas is fed to the welding region by means of the welding torch, which inert gas has a content of 0.5 to 3.0% by volume of at least one oxidising component, characterized in that the inert gas additionally has a content of 0.1 to below 0.5% by volume of hydrogen.

2. The welding method according to claim 1, in which the inert gas has a content of 1.2 to 2.5% by volume of the at least one oxidising component.

3. The welding method according to claim 1, in which the inert gas has a content of 0.5 to 0.4% by volume of hydrogen.

4. The welding method according to claim 1, in which the inert gas in the remaining proportion contains argon and/or helium.

5. The welding method according to claim 1, in which a welding filler selected from the group consisting of a high-alloyed nickel and/or chromium-containing iron material is used.

6. The welding method according to claim 1. in which a work piece selected from the group consisting of a high-alloyed nickel and/or chromium-containing iron material is used.

7. The welding method according to claim 1, in which the inert gas is mixed out of at least two inert gas components.

8. The welding method according to claim 1, in which the inert gas is provided in premixed form.

9. A method for the reduction of a content of nickel oxides and/or chromium (VI) compounds in a welding fumes of a method for the metal inert gas welding, in which a weld filler is fed to a welding torch and via a welding current connection is subjected to a welding current of a welding current source, as a result of which an arc is formed and material of the welding filler in a welding region is transferred onto a work piece which at least in the welding region consists of an alloyed stainless steel and by means of the welding torch an inert gas is fed to the welding region, which inert gas has a content of 0.5 to 3.0% by volume of at least one oxidising component, characterized in that the inert gas additionally has a content of 0.1 to below 0.5% by volume of hydrogen.

10. An inert gas which has a content of 0.5 to 3.0% by volume of at least one oxidising component and a content of 0.1 to below 0.5% by volume of hydrogen.

11. (canceled)
